(19) United States
(12) Patent Application Publication
(10) Pub. No.: US 2026/0239455 A1
(43) Pub. Date: Aug. 13, 2026

(54) HARQ PROCESS ZERO OF RACH PROCEDURE

(71) Applicant: Nokia Technologies Oy, Espoo (FI)

(72) Inventors: Samuli Heikki TURTINEN, Oulu (FI); Chunli WU, Beijing (CN)

(21) Appl. No.: 19/474,087

(22) PCT Filed: Apr. 24, 2023
(86) PCT No.: PCT/CN2023/090350

§ 371 Date: Oct. 9, 2025

(51) Int. Cl. H04W 74/0833; H04L 1/1812

(52) U.S. Cl. CPC H04W 74/0841; H04L 1/1812

(57) ABSTRACT

Example embodiments of the present disclosure relate to a terminal device, a network device, methods, apparatuses and a computer readable storage medium for HARQ process zero of a RACH procedure. A terminal device may transmit an uplink message using a HARQ process with a specific process identifier based on a grant from a network device during a RACH procedure. In some embodiments, if a configured uplink grant has been configured for the specific process identifier, the terminal device may start a CG timer upon a reception of the grant or a transmission of the uplink message. In some embodiments, if the HARQ process with the specific process identifier has been overwritten, the terminal device may perform at least one operation to determine whether a contention resolution is successful. As such, the RACH procedure may be guaranteed or whether the RACH procedure is successful may be confirmed in time.

### FIELD

Example embodiments of the present disclosure generally relate to the field of telecommunication and in particular, to a terminal device, a network device, methods, apparatuses and a computer readable storage medium for hybrid automatic repeat request (HARQ) process zero of a random access channel (RACH) procedure.

### BACKGROUND

RACH procedure may be initiated by user equipment (UE) to establish uplink (UL) synchronization or for other purpose, e.g. to request UL resource. The Msg3 may be transmitted or retransmitted from the UE during the RACH procedure. Normally, HARQ process 0 would be used for Msg3 transmission or retransmission, e.g., with beam failure recovery (BFR) media access control (MAC) control element (CE) in case BFR is triggered. In case a configured grant (CG) using HARQ process 0 is activated or configured, Msg3 transmission or retransmission would be interrupted, which may lead to an un-success of or a delay of the RACH procedure.

### SUMMARY

In general, example embodiments of the present disclosure provide a solution for HARQ process zero of a RACH procedure.

In a first aspect, there is provided a terminal device. The terminal device comprises at least one processor and at least one memory storing instructions that, when executed by the at least one processor, cause the terminal device at least to: receive, from a network device, a grant during a random access procedure; transmit, to the network device, an uplink message based on the grant, the uplink message using a hybrid automatic repeat request (HARQ) process with a specific process identifier; and based on a determination that a configured uplink grant has been configured for the specific process identifier, perform at least one of: upon a reception of the grant or a transmission of the uplink message, starting a configured grant (CG) timer associated with the specific process identifier; or based on a determination that the HARQ process with the specific process identifier has been overwritten, performing at least one operation to determine whether a contention resolution of the random access procedure is successful.

In a second aspect, there is provided a network device. The network device comprises at least one processor and at least one memory storing instructions that, when executed by the at least one processor, cause the network device at least to: transmit, to a terminal device, a grant during a random access procedure; receive, from the terminal device, an uplink message based on the grant, the uplink message using a HARQ process with a specific process identifier; and based on a determination that a configured uplink grant has been configured for the specific process identifier, perform at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In a third aspect, there is provided a method performed by a terminal device. The method comprises: receiving, at a terminal device from a network device, a grant during a random access procedure; transmitting, to the network device, an uplink message based on the grant, the uplink message using a HARQ process with a specific process identifier; and based on a determination that a configured uplink grant has been configured for the specific process identifier, performing at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In a fourth aspect, there is provided a method performed by a network device. The method comprises: transmitting, at a network device to a terminal device, a grant during a random access procedure; receiving, from the terminal device, an uplink message based on the grant, the uplink message using a HARQ process with a specific process identifier; and based on a determination that a configured uplink grant has been configured for the specific process identifier, performing at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In a fifth aspect, there is provided an apparatus. The apparatus comprises: means for receiving, at a terminal device from a network device, a grant during a random access procedure; means for transmitting, to the network device, an uplink message based on the grant, the uplink message using a HARQ process with a specific process identifier; and means for based on a determination that a configured uplink grant has been configured for the specific process identifier, performing at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In a sixth aspect, there is provided an apparatus. The apparatus comprises: means for transmitting, at a network device to a terminal device, a grant during a random access procedure; means for receiving, from the terminal device, an uplink message based on the grant, the uplink message using a HARQ process with a specific process identifier; and means for based on a determination that a configured uplink grant has been configured for the specific process identifier, performing at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In a seventh aspect, there is provided a terminal device. The terminal device comprises: receiving circuitry configured to receive, at a terminal device from a network device, a grant during a random access procedure; transmitting circuitry configured to transmit, to the network device, an uplink message based on the grant, the uplink message using a HARQ process with a specific process identifier; and performing circuitry configured to based on a determination that a configured uplink grant has been configured for the specific process identifier, perform at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In an eighth aspect, there is provided a network device. The network device comprises: transmitting circuitry configured to transmit, at a network device to a terminal device, a grant during a random access procedure; receiving circuitry configured to receive, from the terminal device, an uplink message based on the grant, the uplink message using a HARQ process with a specific process identifier; and performing circuitry configured to based on a determination that a configured uplink grant has been configured for the specific process identifier, perform at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In a ninth aspect, there is provided a non-transitory computer readable medium comprising program instructions for causing an apparatus to perform at least the method in the third or fourth aspect.

In a tenth aspect, there is provided a computer program comprising instructions, which, when executed by an apparatus, cause the apparatus at least to perform the method in the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of 4-step RACH procedure;

FIG. 1B illustrates a schematic diagram of an example of an interrupted HARQ process;

FIG. 2 illustrates an example of a network environment in which some example embodiments of the present disclosure may be implemented;

FIG. 3 illustrates an example of a process flow in accordance with some example embodiments of the present disclosure;

FIG. 4 illustrates a flowchart of a method implemented at a terminal device in accordance with some example embodiments of the present disclosure;

FIG. 5 illustrates a flowchart of a method implemented at a network device in accordance with some example embodiments of the present disclosure;

FIG. 6 illustrates a simplified block diagram of a device that is suitable for implementing some example embodiments of the present disclosure; and

FIG. 7 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT) and so on. Furthermore, the communications in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The RACH procedure, which may also be called as a random access (RA) procedure, refers to a procedure in which the UE can synchronize with its serving cell and can obtain initial resources for uplink transmission. For example, the RA procedure may be related with a state of the UE switching from a radio resource control (RRC) idle state or an RRC inactive state to an RRC connected state.

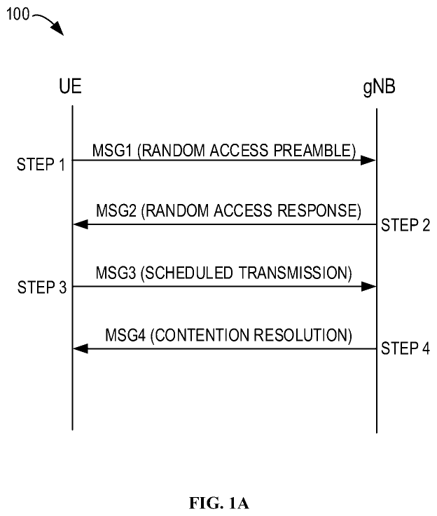

FIG. 1A illustrates an example of 4-step RACH procedure 100. Depending on the type of RACH procedure, the UE may select a random access preamble and a sequence number for the preamble, and sends it on a physical random access channel (PRACH) in a first message (Msg1) to a gNB (5G base station). As shown in FIG. 1A, at step 1, the UE transmits Msg1 to the gNB. Upon receiving Msg1, the gNB sends a random access response (RAR) comprising an initial uplink grant for the UE. As shown in FIG. 1A, at step 2, the gNB replies to the UE by sending in the physical downlink shared channel (PDSCH) Msg2, which may include the detected preamble ID, the time-advance command, a temporary cell-radio network temporary identifier (TC-RNTI), and a UL grant for the transmission of Msg3 on physical uplink shared channel (PUSCH). Using the initial uplink grant provided in Msg2, the UE transmits Msg3 on the PUSCH, e.g., for contention resolution, at step 3 as shown in FIG. 1A. A fourth message (Msg4) comprises the UE's identity, confirming that the gNB has correctly identified the UE, and any contention access attempt(s) from other UEs have been resolved. As shown in FIG. 1A, at step 4, the gNB transmits Msg4, e.g., the contention resolution message with the contention-resolution ID or PDCCH addressed to C-RNTI as contention resolution. This completes the 4-step RACH procedure 100.

In addition to 4-step RACH procedure, there is also a 2-step RACH procedure for partitioning of RACH resources, which can improve the overall latency of the RACH procedure.

Uplink grant may be received dynamically on the PDCCH, in a random access response, configured semi-persistently by RRC. The MAC entity shall have an uplink grant to transmit on the UL-SCH. To perform the requested transmissions, the MAC layer receives HARQ information from lower layers.

Each HARQ process is associated with a HARQ process identifier. For UL transmission with UL grant in the RAR, HARQ process identifier (ID) 0 is used. Msg3 transmission (i.e., UL grant received in RAR or retransmission with TC-RNTI) is always applying HARQ process ID 0 (PID #0).

Downlink Control Information (DCI) is a set of information which schedules downlink data channel (e.g., PDSCH) or uplink data channel (e.g., PUSCH), and is usually required for every transmission for dynamic scheduling. With configured scheduling, a gNB can schedule transmission over the PDSCH/PUSCH without the need to send DCI for every transmission. The gNB configures the UE with scheduling parameters via RRC, and gNB and UE then transmit PDSCH and PUSCH according to the specified parameters. They can be dynamically activated and deactivated by DCI. This helps the gNB to reduce the load of PHY/MAC scheduling. Configured Scheduling in uplink (UL) direction (UE to gNB) is called as Configured Grant (CG).

For configured uplink grants, the HARQ process ID associated with a UL transmission may be derived. In some cases, a configured grant using HARQ process ID 0 may be activated or configured.

FIG. 1B illustrates a schematic diagram of an example of an interrupted HARQ process 150. As shown at 152, the UE could perform a random access procedure for SpCell BFR and HARQ process 0 may be used for Msg 3 transmission with BFR MAC CE.

However, if the configured grant using HARQ process 0 is activated or configured, it is possible that Msg3 in HARQ buffer for HARQ process 0 may be replaced by a new MAC PDU, as shown at 160. As such, the Msg3 transmission would be interrupted since there is no BFR MAC CE buffered any more, as shown at 170. Accordingly, it would lead to an un-success of or a delay of the RACH procedure. Therefore, the conflict between sharing HARQ process between configured grant and random access procedure should be further studied and resolved.

Example embodiments of the present disclosure provide a solution for HARQ process zero of a RACH procedure. In some embodiments, a terminal device may receive a grant during a random access procedure and further transmit an uplink message which uses a HARQ process with a specific process identifier. In some embodiments, if a configured uplink grant has been configured for the specific process identifier, the terminal device may start a CG timer upon a reception of the grant or a transmission of the uplink message. In some embodiments, if the HARQ process with the specific process identifier has been overwritten, the terminal device may perform at least one operation to determine whether a contention resolution of the random access procedure is successful. As such, the RACH procedure may be guaranteed or whether the RACH procedure is successful may be confirmed in time. Principles and some example embodiments of the present disclosure will be described in detail below with reference to the accompanying drawings.

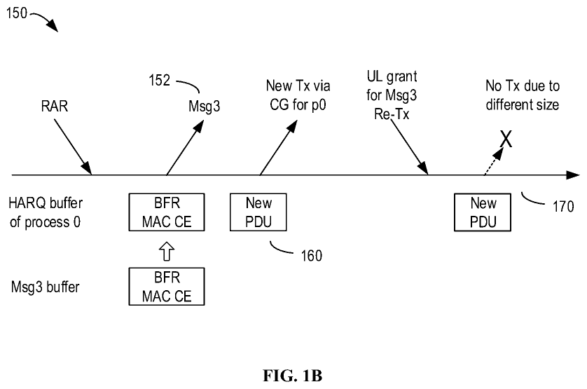

FIG. 2 illustrates an example of a network environment 200 in which some example embodiments of the present disclosure may be implemented. The environment 200, which may be a part of a communication network, comprises a terminal device 210 and a network device 220. The network environment 200 may also be called as a network system, a communication environment, a communication network, a communication system, or the like, the present disclosure does not limit this aspect.

The environment 200 may comprise any suitable number of devices and cells. In the environment 200, the network device 220 can provide services to the terminal device 210, and the network device 220 and the terminal device 210 may communicate data and control information with each other. In some embodiments, the network device 220 and the terminal device 210 may communicate with direct links/channels.

In the environment 200, a link from the network device 220 to the terminal device 210 is referred to as a downlink (DL), while a link from the terminal device 210 to the network device 220 is referred to as an uplink (UL). In downlink, the network device 220 is a transmitting (TX) device (or a transmitter) and the terminal device 210 is a receiving (RX) device (or a receiver). In uplink, the terminal device 210 is a transmitting TX device (or a transmitter) and the network device 220 is a RX device (or a receiver). It is to be understood that the network device 220 may provide one or more serving cells. In some embodiments, the network device 220 can provide multiple cells.

Communications in the network environment 200 may be implemented according to any proper communication protocol(s), comprising, but not limited to, cellular communication protocols of the first generation (1G), the second generation (2G), the third generation (3G), the fourth generation (4G), the fifth generation (1G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 210 and the network device 220) and their connection relationships and types shown in FIG. 2 are only for the purpose of illustration without suggesting any limitation. For example, the environment 200 may include any suitable numbers of devices adapted for implementing embodiments of the present disclosure. For example, while FIG. 2 depicts the terminal device 210 as a mobile phone; the terminal device 210 may be any type of user equipment.

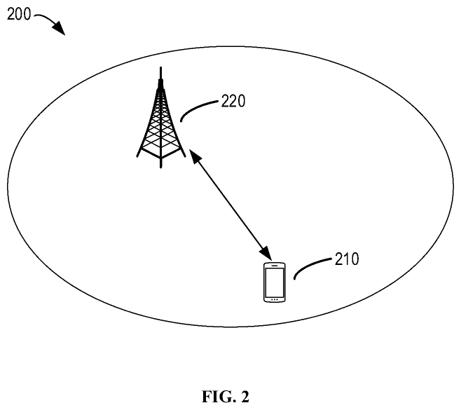

FIG. 3 illustrates an example of a process flow 300 in accordance with some example embodiments of the present disclosure. For the purpose of discussion, the process flow 300 will be described with reference to FIG. 2. The process flow 300 involves the terminal device 210 and the network device 220. It would be appreciated that although the process flow 300 has been described in the network environment 200 of FIG. 2, this process flow may be likewise applied to other communication scenarios.

The network device 220 transmits 310 a grant 312 to the terminal device 210, where the grant 312 may transmitted during a random access procedure. In some examples, the grant 312 may be associated with Msg2 or Msg3 in a random access procedure.

In addition or alternatively, the terminal device 210 has transmitted Msg1 to the network device 220. For example, the grant 312 may be transmitted by the network device 220 in response to receiving Msg1 from the terminal device 210. In some example embodiments, the grant 312 may be an uplink grant. In some examples, the network device 220 may transmit an RAR which includes an uplink grant. In some examples, the network device 220 may transmit a fallback RAR which includes an uplink grant.

In addition or alternatively, the network device 220 has transmitted the RAR to the terminal device 210, and the terminal device 210 has transmitted Msg3 to the network device 220. For example, the RAR includes an uplink grant and a TC-RNTI. In some example embodiments, the grant 312 may be a retransmission grant. In some examples, the network device 220 may transmit a retransmission grant which is addressed to the TC-RNTI. For example, the retransmission grant may be carried in a DCI over PDCCH.

On the other side of communication, the terminal device 210 receives 314 the grant 312. For example, the terminal device 210 may obtain the uplink grant in the RAR or in the fallback RAR. For example, the terminal device 210 may obtain the retransmission grant addressed to the TC-RNTI.

The terminal device 210 transmits 320 an uplink message 322 to the network device 220 based on the grant 312. In some examples, the uplink message 322 may use a HARQ process with a specific process identifier.

For example, the uplink message 322 may be Msg3, and the specific process identifier may be process identifier 0 (PID #0). In other words, the terminal device 210 may transmit Msg3 using PID #0. However, it is to be understood that another process identifier may be the specific process identifier in some other cases, such as 1, 2, or another value, the present disclosure does not limit this aspect. For ease of description, an illustrated example of “Msg3 using PID #0” will be discussed in detail.

In some example embodiments, the transmission of the uplink message 322 may be an initial transmission, e.g., the grant 312 is an uplink grant in the RAR. In some other example embodiments, the transmission of the uplink message 322 may be a retransmission, e.g., the grant 312 is a retransmission grant. In this event, the term “transmit” in the present disclosure includes “initially transmit” or “retransmit”. For example, the terminal device 210 transmits or retransmits the uplink message 322 at 320.

In the present disclosure, it is assumed that a configured grant (CG) has been configured. For example, the network device 220 has configured a CG for the terminal device 210. For example, a CG configuration may indicate that there are multiple CG transmission occasions, and each CG transmission occasion may be associated with a HARQ process identifier.

In some example embodiments, if a configured uplink grant has been configured for the specific process identifier (such as HARQ PID #0), then there is a possibility that the HARQ process used by the uplink message 322 may be overridden. In some example embodiments, a solution 330 or 340 may be used to handle this issue.

In some embodiments, in solution 330 the terminal device 210 may start 332 a configured grant timer associated with the specific process identifier upon a reception of the grant 312 or a transmission of the uplink message 322.

It is to be noted that starting a timer in the present disclosure may include starting the timer if the timer is not running and restarting the timer if the timer is running. In other words, in solution 330, the terminal device 210 may start the configured grant timer associated with the specific process identifier or restart the running configured grant timer associated with the specific process identifier, upon a reception of the grant 312 or a transmission of the uplink message 322.

The configured grant timer may be the configuredGrantTimer. In case there is a CG transmission occasion associated with the specific process identifier, the CG transmission occasion will not be used for uplink transmission since the configured grant timer associated with the specific process identifier is running. In other words, if a CG transmission occasion is associated with the specific process identifier and the configured grant timer associated with the specific process identifier is running, the terminal device 210 may leave the CG transmission occasion unused.

As such, the HARQ process used by the uplink message 322 (such as Msg3) would not be overwritten by a configured grant transmission, for example, this solution prevents overwriting the HARQ PID #0 used by Msg3.

Alternatively, if the configured grant timer associated with the specific process identifier expires and a contention resolution timer is running, the terminal device 210 may restart the CG timer associated with the specific process identifier. In case the contention resolution timer (such as ra-ContentionResolutionTimer) is still running, the random access procedure has not been finished, then the terminal device 210 may expect not to overwrite the HARQ PID #0 used by Msg3, therefore, the configured grant timer associated with the specific process identifier may be restarted upon expiring.

Alternatively, if the contention resolution of the random access procedure is successful, the terminal device 210 may stop the configured grant timer associated with the specific process identifier. In case the contention resolution is successful, the HARQ process may be used by other transmission, then the configured grant timer associated with the specific process identifier may be stopped, therefore, a configured grant transmission may be performed by using the specific process identifier.

Since Msg3 may be used to transmit, e.g., certain type of BFR MAC CE, which would be crucial for the network device 220 to receive rather than new data transmission over configured grant, the solution of starting the configured grant timer associated with the specific process identifier upon a reception of the grant 312 or a transmission of the uplink message 322 may avoid overwriting the HARQ process.

In some other embodiments, in solution 340, the terminal device 210 may perform 342 at least one operation to determine whether a contention resolution of the random access procedure is successful. Specifically, if a contention resolution timer (i.e., ra-ContentionResolutionTimer) is running and the HARQ process with the specific process identifier has been overwritten by a CG transmission, the terminal device 210 may perform the at least one operation to determine whether the contention resolution of the random access procedure is successful.

In some examples, if a contention resolution timer is running and a CG confirmation is triggered, the terminal device 210 may overwrite the HARQ process with the specific process identifier by the CG transmission in a CG transmission occasion associated with the specific process identifier. For example, the terminal device 210 may overwrite HARQ PID #0 consisting Msg3 while ra-ContentionResolutionTimer is running, only in case the CG confirmation is triggered (i.e., CG confirmation MAC CE is to be included in the CG transmission). In other words, if a CG transmission associated HARQ PID #0 includes the CG confirmation MAC CE, then the CG transmission can be performed and the HARQ PID #0 would be overwritten.

In some examples, the at least one operation may include: discarding the TC-RNTI associated with the uplink message; stopping the contention resolution timer; and determining that the contention resolution is unsuccessful. For example, the terminal device 210 may discards TC-RNTI, stop the ra-ContentionResolutionTimer and consider the contention resolution unsuccessful.

In some other examples, the at least one operation may include: determining that the contention resolution is unsuccessful if a retransmission grant addressed to a TC-RNTI is received, or determining that the contention resolution is successful if a PDCCH for the contention resolution is received. In addition or alternatively, the at least one operation may include: stopping the contention resolution timer if a retransmission grant addressed to a TC-RNTI is received.

It is to be understood that the term “PDCCH for contention resolution” in the present disclosure may be referred to as “PDCCH addressed to C-RNTI for contention resolution”, which may mean: (a) if the Random Access procedure was initiated for SpCell beam failure recovery or for beam failure recovery of both BFD-RS sets of SpCell and the PDCCH transmission is addressed to the C-RNTI; (b) if the Random Access procedure was initiated by a PDCCH order and the PDCCH transmission is addressed to the C-RNTI; or (c) if the Random Access procedure was initiated by the MAC sublayer itself or by the RRC sublayer and the PDCCH transmission is addressed to the C-RNTI and contains a UL grant for a new transmission.

For example, if a retransmission uplink grant addressed to the TC-RNTI is received after MSG3 is overridden by a CG transmission, the terminal device 210 may stop the ra-ContentionResolutionTimer and consider the contention resolution unsuccessful. For example, if contention resolution (with PDCCH addressed to C-RNTI) is received, the terminal device 210 may consider the contention resolution successful, and the random access procedure is successfully completed.

In some other examples, the at least one operation may include: discarding a TC-RNTI associated with the uplink message; and determining that the contention resolution is successful if a PDCCH for the contention resolution is received. In addition or alternatively, the at least one operation may include: determining that the contention resolution is unsuccessful if no PDCCH for the contention resolution is received before an expiry of the contention resolution timer.

For example, the terminal device 210 may discard TC-RNTI but maintain ra-ContentionResolutionTimer running, accordingly, the terminal device 210 cannot receive (or effectively does not attempt to decode) re-transmission grant for Msg3 re-transmission but may still receive contention resolution success, i.e., PDCCH transmission addressed to the C-RNTI, or PDCCH transmission addressed to the C-RNTI and containing a UL grant for a new transmission (or DL in case of BFR).

For example, this solution may prevent decoding retransmission grant for Msg3 transmission, if CG transmission is used to overwrite the HARQ buffer used for Msg3 transmissions.

Since a CG transmission may convey CG confirmation MAC CE (while Msg3 might not convey any important control information), the overriding may make sense in some cases. Accordingly the HARQ process for Msg3 may be overwritten by the CG transmission associated with the same process identifier (such as PID #0). However, if the network device 220 schedules re-transmission grant with a different transport block size (TBS), an error may occur. According to the solution 340 in the present disclosure, the terminal device 210 may perform at least one operation to determine whether the contention resolution is successfully, and thus the communication between the terminal device 210 and the network device 220 may be guaranteed.

On the other side of communication, the network device 220 receives 324 the uplink transmission 322, such as Msg3 using HARQ PID #0. In some example embodiments, the network device 220 may further perform a solution 330 or 340.

In some embodiments, the network device 220 may start 334 a configured grant timer associated with the specific process identifier upon a transmission of the grant 312 or a reception of the uplink message 322. Similarly with that discussed with reference to 332, the network device 220 may start the configured grant timer associated with the specific process identifier or restart the running configured grant timer associated with the specific process identifier, upon a transmission of the grant 312 or a reception of the uplink message 322.

In some other embodiments, the network device 220 may perform 344 at least one operation to determine whether a contention resolution of the random access procedure is successful. Specifically, if a contention resolution timer (i.e., ra-ContentionResolutionTimer) is running and the HARQ process with the specific process identifier has been overwritten by a CG transmission, the network device 220 may perform at least one operation to determine whether a contention resolution of the random access procedure is successful.

In some examples, if a contention resolution timer is running and a CG confirmation is triggered, the network device 220 may overwrite the HARQ process with the specific process identifier by the CG transmission in a CG transmission occasion associated with the specific process identifier.

In some examples, the at least one operation may include: discarding the TC-RNTI associated with the uplink message; stopping the contention resolution timer; and determining that the contention resolution is unsuccessful.

In some other examples, the at least one operation may include: if the uplink message is unsuccessfully decoded, transmitting, to the terminal device, a retransmission grant addressed to a TC-RNTI; and determining that the contention resolution is unsuccessful. In addition or alternatively, the at least one operation may include: stopping the contention resolution timer upon a transmission of the retransmission grant addressed to the TC-RNTI.

In some other examples, the at least one operation may include: if the uplink message is successfully decoded, transmitting a PDCCH for the contention resolution to the terminal device 210; and determining that the contention resolution is successful.

In some other examples, the at least one operation may include: discarding a TC-RNTI associated with the uplink message; if the uplink message is successfully decoded, transmitting a PDCCH for the contention resolution to the terminal device 210; and determining that the contention resolution is successful.

In some other examples, the at least one operation may include: discarding a TC-RNTI associated with the uplink message; and if the uplink message is unsuccessfully decoded, determining that the contention resolution is unsuccessful.

It is to be understood that the operations 334 and 344 at the network device 220 are similar with the operations 332 and 342 at the terminal device 210 respectively, and thus will not be repeat for ease of description.

According to the embodiments with reference to FIG. 3, a solution for HARQ process zero of a RACH procedure is proposed. In some embodiments, a terminal device may transmit an uplink message which uses a HARQ process with a specific process identifier, based on a grant from the network device. In some embodiments, the terminal device may start a CG timer upon a reception of the grant or a transmission of the uplink message, if a configured uplink grant has been configured for the specific process identifier. As such, an overwriting of the HARQ process used by the uplink message may be prevented.

The above various embodiments of the present disclosure may have partial impact to the current specification. For example, the current specification may be updated (underlined) as follows in view of the above various embodiments of the present disclosure. Regarding Clause 5.4.1 in TS 38.321, it may include UL grant reception, which may be updated as:

5.4.1 UL Grant reception

```
Uplink grant is either received dynamically on the PDCCH, in a Random Access Response, configured
semi-persistently by RRC or determined to be associated with the PUSCH resource of MSGA as specified
in clause 5.1.2a. The MAC entity shall have an uplink grant to transmit on the UL-SCH. To perform the
requested transmissions, the MAC layer receives HARQ information from lower layers. An uplink grant
addressed to CS-RNTI with NDI = 0 is considered as a configured uplink grant. An uplink grant addressed
to CS-RNTI with NDI = 1 is considered as a dynamic uplink grant.
If the MAC entity has a C-RNTI, a Temporary C-RNTI, or CS-RNTI, the MAC entity shall for each
PDCCH occasion and for each Serving Cell belonging to a TAG that has a running timeAlignmentTimer or
a running cg-SDT-TimeAlignmentTimer and for each grant received for this PDCCH occasion:
  1> if an uplink grant for this Serving Cell has been received on the PDCCH for the MAC entity's
    C-RNTI or Temporary C-RNTI; or
  1> if an uplink grant has been received in a Random Access Response:
    2> if the uplink grant is for MAC entity's Temporary C-RNTI or if the uplink grant has been
      received in a Random Access Response:
      3> start or restart the configuredGrantTimer for the corresponding HARQ process, if
        configured;
    2> if the uplink grant is for MAC entity's C-RNTI and if the previous uplink grant delivered to the
      HARQ entity for the same HARQ process was either an uplink grant received for the MAC
      entity's CS-RNTI or a configured uplink grant:
      3> consider the NDI to have been toggled for the corresponding HARQ process regardless of
        the value of the NDI.
    2> if the uplink grant is for MAC entity's C-RNTI, and the identified HARQ process is configured
      for a configured uplink grant:
      3> start or restart the configuredGrantTimer for the corresponding HARQ process, if
        configured;
      3> stop the cg-RetransmissionTimer for the corresponding HARQ process, if running.
    2> stop the cg-SDT-RetransmissionTimer for the corresponding HARQ process, if running.
    2> deliver the uplink grant and the associated HARQ information to the HARQ entity.
  1> else if an uplink grant for this PDCCH occasion has been received for this Serving Cell on the
    PDCCH for the MAC entity's CS-RNTI:
    2> if the NDI in the received HARQ information is 1:
      3> consider the NDI for the corresponding HARQ process not to have been toggled;
      3> start or restart the configuredGrantTimer for the corresponding HARQ process, if
        configured;
      3> stop the cg-RetransmissionTimer for the corresponding HARQ process, if running;
      3> stop the cg-SDT-RetransmissionTimer for the corresponding HARQ process, if running;
      3> deliver the uplink grant and the associated HARQ information to the HARQ entity;
      3> if a logical channel associated with a DRB configured with survivalTimeStateSupport is
        multiplexed in the MAC PDU stored in the HARQ buffer for the corresponding HARQ
        process:
        4> trigger activation of PDCP duplication for all configured RLC entities of the DRB.
    2> else if the NDI in the received HARQ information is 0:
      3> if PDCCH contents indicate configured grant Type 2 deactivation:
        4> trigger configured uplink grant confirmation.
      3> else if PDCCH contents indicate configured grant Type 2 activation:
        4> trigger configured uplink grant confirmation;
        4> store the uplink grant for this Serving Cell and the associated HARQ information as
          configured uplink grant;
        4> initialise or re-initialise the configured uplink grant for this Serving Cell to start in the
          associated PUSCH duration and to recur according to rules in clause 5.8.2;
        4> stop the configuredGrantTimer for the corresponding HARQ process, if running;
        4> stop the cg-RetransmissionTimer for the corresponding HARQ process, if running.
For each Serving Cell and each configured uplink grant, if configured and activated, the MAC entity shall:
  1> if the MAC entity is configured with lch-basedPrioritization, and the PUSCH duration of the
    configured uplink grant does not overlap with the PUSCH duration of an uplink grant received in a
    Random Access Response or with the PUSCH duration of an uplink grant addressed to Temporary
    C-RNTI or the PUSCH duration of a MSGA payload for this Serving Cell; or
  1> if the MAC entity is not configured with lch-basedPrioritization, and the PUSCH duration of the
    configured uplink grant does not overlap with the PUSCH duration of an uplink grant received on
    the PDCCH or in a Random Access Response or the PUSCH duration of a MSGA payload for this
    Serving Cell:
    2> set the HARQ Process ID to the HARQ Process ID associated with this PUSCH duration;
    2> if, for the corresponding HARQ process, the configuredGrantTimer is not running and
      cg-RetransmissionTimer is not configured and cg-SDT-RetransmissionTimer is not configured
      (i.e. new transmission):
      3> if there is an on-going CG-SDT procedure and PDCCH addressed to the MAC entity's
      C-RNTI has been received; or
      3> if there is no on-going CG-SDT procedure:
        4> consider the NDI bit for the corresponding HARQ process to have been toggled;
        4> if the HARQ process number is 0 and if the ra-ContentionResolutionTimer is running:
          5> stop ra-ContentionResolutionTimer;
          5> discard the TEMPORARY C-RNTI;
          5> consider this Contention Resolution not successful and perform actions as specified in
            clause 5.1.5.
        4> deliver the configured uplink grant and the associated HARQ information to the HARQ
          entity.
    2> else if the cg-RetransmissionTimer for the corresponding HARQ process is configured and not
      running, then for the corresponding HARQ process:
      3> if the configuredGrantTimer is not running, and the HARQ process is not pending (i.e. new
        transmission):
        4> consider the NDI bit to have been toggled;
        4> deliver the configured uplink grant and the associated HARQ information to the HARQ
          entity.
      3> else if the previous uplink grant delivered to the HARQ entity for the same HARQ process
        was a configured uplink grant (i.e. retransmission on configured grant):
        4> deliver the configured uplink grant and the associated HARQ information to the HARQ
          entity.
    2> else if the cg-SDT-RetransmissionTimer is configured and not running for the corresponding
      HARQ process;
      3> if the configured uplink grant is for the initial transmission for the CG-SDT with CCCH
        message (i.e., initial new transmission); or
      3> if the configuredGrantTimer is not running or not configured, and PDCCH addressed to the
        MAC entity's C-RNTI has been received after the initial transmission of the CG-SDT with
        CCCH message (i.e., subsequent new transmission):
        4> consider the NDI bit to have been toggled;
        4> deliver the configured uplink grant and the associated HARQ information to the HARQ
          entity.
      3> else if the previous uplink grant delivered to the HARQ entity for the same HARQ process
        was a configured uplink grant for initial transmission of CG-SDT with CCCH message or for
        its retransmission; and
      3> if PDCCH addressed to the MAC entity's C-RNTI has not been received (i.e., retransmission
        for initial CG-SDT transmission):
        4> consider the NDI bit to have not been toggled;
        4> deliver the configured uplink grant and the associated HARQ information to the HARQ
          entity.
```

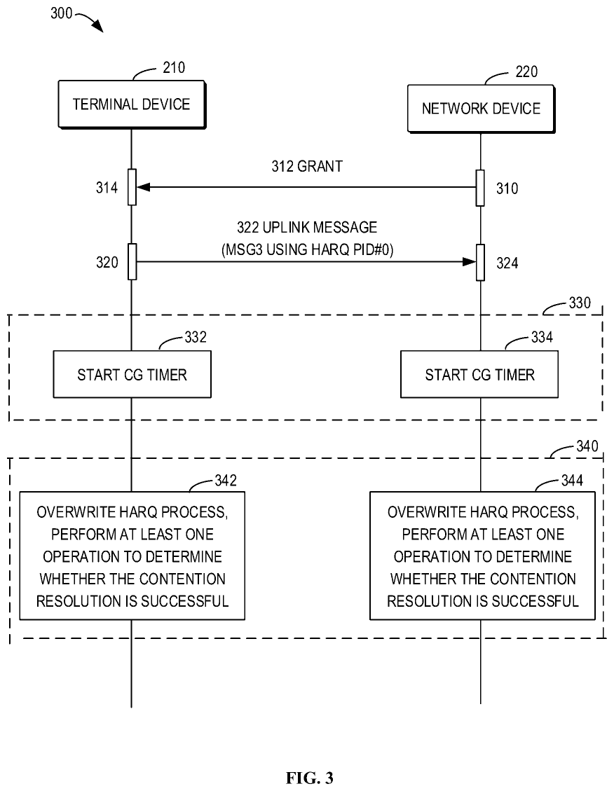

FIG. 4 illustrates a flowchart of a method 400 implemented at a terminal device in accordance with some example embodiments of the present disclosure. For the purpose of discussion, the method 400 will be described from the perspective of the terminal device 210 with reference to FIG. 2.

At block 410, the terminal device 210 receives, from a network device, a grant during a random access procedure. At block 420, the terminal device 210 transmits, to the network device, an uplink message based on the grant, the uplink message using a HARQ process with a specific process identifier. At block 430, if a configured uplink grant has been configured for the specific process identifier, the terminal device 210 performs at least 10 one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In some example embodiments, if the CG timer associated with the specific process identifier expires and a contention resolution timer is running, the terminal device 210 restarts the CG timer associated with the specific process identifier.

In some example embodiments, if the contention resolution of the random access procedure is successful, the terminal device 210 stops the CG timer.

In some example embodiments, if a CG transmission occasion is associated with the specific process identifier and the CG timer is running, the terminal device 210 leaves the CG transmission occasion unused.

In some example embodiments, if a contention resolution timer is running and the HARQ process with the specific process identifier has been overwritten by a CG transmission, the terminal device 210 performs the at least one operation to determine whether the contention resolution of the random access procedure is successful.

In some example embodiments, the at least one operation comprises: discarding a TC-RNTI associated with the uplink message; stopping the contention resolution timer; and determining that the contention resolution is unsuccessful.

In some example embodiments, the at least one operation comprises: based on a determination that a retransmission grant addressed to a TC-RNTI is received, determining that the contention resolution is unsuccessful; or based on a determination that a PDCCH for the contention resolution is received, determining that the contention resolution is successful. In some example embodiments, the at least one operation further comprises: based on a determination that a retransmission grant addressed to a TC-RNTI is received, stopping the contention resolution timer.

In some example embodiments, the at least one operation comprises: discarding a TC-RNTI associated with the uplink message; and based on a determination that a PDCCH for the contention resolution is received, determining that the contention resolution is successful. In some example embodiments, the at least one operation further comprises: based on a determination that no PDCCH for the contention resolution is received before an expiry of the contention resolution timer, determining that the contention resolution is unsuccessful.

In some example embodiments, if a contention resolution timer is running and a CG confirmation is triggered, the terminal device 210 overwrites the HARQ process with the specific process identifier by the CG transmission in a CG transmission occasion associated with the specific process identifier.

In some example embodiments, the grant comprises at least one of: an uplink grant in an RAR or in a fallback RAR, or a retransmission grant addressed to a TC-RNTI.

In some example embodiments, the uplink message is message 3, and wherein the specific process identifier is process identifier 0.

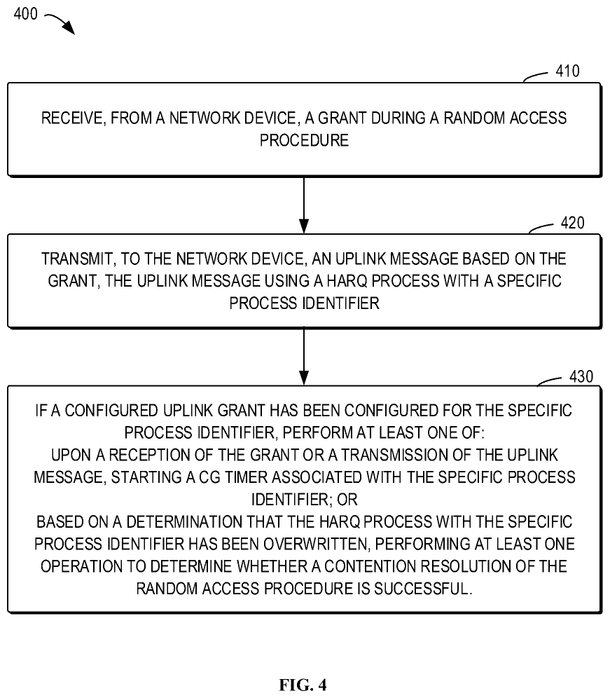

FIG. 5 illustrates a flowchart of a method 500 implemented at a network device in accordance with some example embodiments of the present disclosure. For the purpose of discussion, the method 500 will be described from the perspective of the network device 220 with reference to FIG. 2.

At block 510, the network device 220 transmits, to a terminal device, a grant during a random access procedure. At block 520, the network device 220 receives, from the terminal device, an uplink message based on the grant, where the uplink message uses a HARQ process with a specific process identifier. At block 530, if a configured uplink grant has been configured for the specific process identifier, the network device 220 performs at least one of: upon a reception of the grant or a transmission of the uplink message, starting a CG timer associated with the specific process identifier; or based on a determination that the HARQ process with the specific process identifier has been overwritten, performing at least one operation to determine whether a contention resolution of the random access procedure is successful.

In some example embodiments, if the CG timer associated with the specific process identifier expires and a contention resolution timer is running, the network device 220 restarts the CG timer associated with the specific process identifier.

In some example embodiments, if the contention resolution of the random access procedure is successful, the network device 220 stops the CG timer.

In some example embodiments, if a CG transmission occasion is associated with the specific process identifier and the CG timer is running, the network device 220 stops monitoring the CG transmission occasion.

In some example embodiments, if a contention resolution timer is running and the HARQ process with the specific process identifier has been overwritten by a CG transmission, the network device 220 performs the at least one operation to determine whether the contention resolution of the random access procedure is successful.

In some example embodiments, the at least one operation comprises: discarding a TC-RNTI associated with the uplink message; stopping the contention resolution timer; and determining that the contention resolution is unsuccessful.

In some example embodiments, the at least one operation comprises: based on a determination that the uplink message is unsuccessfully decoded, transmitting, to the terminal device, a retransmission grant addressed to a TC-RNTI; and determining that the contention resolution is unsuccessful. In some example embodiments, the at least one operation further comprises: upon a transmission of the retransmission grant addressed to the TC-RNTI, stopping the contention resolution timer.

In some example embodiments, the at least one operation comprises: based on a determination that the uplink message is successfully decoded, transmitting, to the terminal device, a physical downlink control channel (PDCCH) for the contention resolution; and determining that the contention resolution is successful.

In some example embodiments, the at least one operation comprises: discarding a TC-RNTI associated with the uplink message; based on a determination that the uplink message is successfully decoded, transmitting, to the terminal device, a PDCCH for the contention resolution; and determining that the contention resolution is successful.

In some example embodiments, the at least one operation comprises: discarding a TC-RNTI associated with the uplink message; and based on a determination that the uplink message is unsuccessfully decoded, determining that the contention resolution is unsuccessful. In some example embodiments, the network device is further caused to: based on a determination that a contention resolution timer is running and a CG confirmation is triggered, overwrite the HARQ process with the specific process identifier by the CG transmission in a CG transmission occasion associated with the specific process identifier.

In some example embodiments, the grant comprises at least one of: an uplink grant in an RAR or in a fallback RAR, or a retransmission grant addressed to a TC-RNTI.

In some example embodiments, the uplink message is message 3, and wherein the specific process identifier is process identifier 0.

In some example embodiments, an apparatus capable of performing the method 400 (for example, the terminal device 210) may comprise means for performing the respective steps of the method 400. The means may be implemented in any suitable form. For example, the means may be implemented in a circuitry or software module.

In some example embodiments, the apparatus comprises: means for receiving, at a terminal device from a network device, a grant during a random access procedure; means for transmitting, to the network device, an uplink message based on the grant, the uplink message using a hybrid automatic repeat request (HARQ) process with a specific process identifier; and means for based on a determination that a configured uplink grant has been configured for the specific process identifier, performing at least one of: upon a reception of the grant or a transmission of the uplink message, starting a configured grant (CG) timer associated with the specific process identifier; or based on a determination that the HARQ process with the specific process identifier has been overwritten, performing at least one operation to determine whether a contention resolution of the random access procedure is successful.

In some example embodiments, the apparatus comprises: means for based on a determination that the CG timer associated with the specific process identifier expires and a contention resolution timer is running, restarting the CG timer associated with the specific process identifier.

In some example embodiments, the apparatus comprises: means for based on a determination that the contention resolution of the random access procedure is successful, stopping the CG timer.

In some example embodiments, the apparatus comprises: means for based on a determination that a CG transmission occasion is associated with the specific process identifier and the CG timer is running, leaving the CG transmission occasion unused.

In some example embodiments, the apparatus comprises: means for based on a determination that a contention resolution timer is running and the HARQ process with the specific process identifier has been overwritten by a CG transmission, performing the at least one operation to determine whether the contention resolution of the random access procedure is successful.

In some example embodiments, the apparatus comprises: means for performing the at least one operation comprising: discarding a temporary cell-radio network temporary identifier (TC-RNTI) associated with the uplink message; stopping the contention resolution timer; and determining that the contention resolution is unsuccessful.

In some example embodiments, the apparatus comprises: means for performing the at least one operation comprising: based on a determination that a retransmission grant addressed to a TC-RNTI is received, determining that the contention resolution is unsuccessful; or based on a determination that a physical downlink control channel (PDCCH) for the contention resolution is received, determining that the contention resolution is successful.

In some example embodiments, the apparatus comprises: means for performing the at least one operation comprising: based on a determination that a retransmission grant addressed to a TC-RNTI is received, stopping the contention resolution timer.

In some example embodiments, the apparatus comprises: means for performing the at least one operation comprising: discarding a TC-RNTI associated with the uplink message; and based on a determination that a PDCCH for the contention resolution is received, determining that the contention resolution is successful.

In some example embodiments, the apparatus comprises: means for performing the at least one operation comprising: based on a determination that no PDCCH for the contention resolution is received before an expiry of the contention resolution timer, determining that the contention resolution is unsuccessful.

In some example embodiments, the apparatus comprises: means for based on a determination that a contention resolution timer is running and a CG confirmation is triggered, overwriting the HARQ process with the specific process identifier by the CG transmission in a CG transmission occasion associated with the specific process identifier.

In some example embodiments, the grant comprises at least one of: an uplink grant in a random access response (RAR) or in a fallback RAR, or a retransmission grant addressed to a TC-RNTI.

In some example embodiments, the uplink message is message 3, and wherein the specific process identifier is process identifier 0.

In some example embodiments, an apparatus capable of performing the method 500 (for example, the network device 220 may comprise means for performing the respective steps of the method 500. The means may be implemented in any suitable form. For example, the means may be implemented in a circuitry or software module.

In some example embodiments, the apparatus comprises: means for transmitting, at a network device to a terminal device, a grant during a random access procedure; means for receiving, from the terminal device, an uplink message based on the grant, the uplink message using a hybrid automatic repeat request (HARQ) process with a specific process identifier; and means for based on a determination that a configured uplink grant has been configured for the specific process identifier, performing at least one of: upon a reception of the grant or a transmission of the uplink message, starting a configured grant (CG) timer associated with the specific process identifier; or based on a determination that the HARQ process with the specific process identifier has been overwritten, performing at least one operation to determine whether a contention resolution of the random access procedure is successful.

In some example embodiments, the apparatus comprises: means for based on a determination that the CG timer associated with the specific process identifier expires and a contention resolution timer is running, restarting the CG timer associated with the specific process identifier.

In some example embodiments, the apparatus comprises: means for based on a determination that the contention resolution of the random access procedure is successful, stopping the CG timer.

In some example embodiments, the apparatus comprises: means for based on a determination that a CG transmission occasion is associated with the specific process identifier and the CG timer is running, stopping monitoring the CG transmission occasion.

In some example embodiments, the apparatus comprises: means for based on a determination that a contention resolution timer is running and the HARQ process with the specific process identifier has been overwritten by a CG transmission, performing the at least one operation to determine whether the contention resolution of the random access procedure is successful.

In some example embodiments, the apparatus comprises: means for performing the at least one operation comprising: discarding a temporary cell-radio network temporary identifier (TC-RNTI) associated with the uplink message; stopping the contention resolution timer; and determining that the contention resolution is unsuccessful.

In some example embodiments, the apparatus comprises: means for performing the at least one operation comprising: based on a determination that the uplink message is unsuccessfully decoded, transmitting, to the terminal device, a retransmission grant addressed to a TC-RNTI; and determining that the contention resolution is unsuccessful.

In some example embodiments, the apparatus comprises: means for performing the at least one operation comprising: upon a transmission of the retransmission grant addressed to the TC-RNTI, stopping the contention resolution timer.

In some example embodiments, the apparatus comprises: means for performing the at least one operation comprising: based on a determination that the uplink message is successfully decoded, transmitting, to the terminal device, a physical downlink control channel (PDCCH) for the contention resolution; and determining that the contention resolution is successful.

In some example embodiments, the apparatus comprises: means for performing the at least one operation comprising: discarding a TC-RNTI associated with the uplink message; based on a determination that the uplink message is successfully decoded, transmitting, to the terminal device, a PDCCH for the contention resolution; and determining that the contention resolution is successful.

In some example embodiments, the apparatus comprises: means for performing the at least one operation comprising: discarding a TC-RNTI associated with the uplink message; and based on a determination that the uplink message is unsuccessfully decoded, determining that the contention resolution is unsuccessful.

In some example embodiments, the apparatus comprises: means for based on a determination that a contention resolution timer is running and a CG confirmation is triggered, overwriting the HARQ process with the specific process identifier by the CG transmission in a CG transmission occasion associated with the specific process identifier.

In some example embodiments, the grant comprises at least one of: an uplink grant in a random access response (RAR) or in a fallback RAR, or a retransmission grant addressed to a TC-RNTI.

In some example embodiments, the uplink message is message 3, and wherein the specific process identifier is process identifier 0.

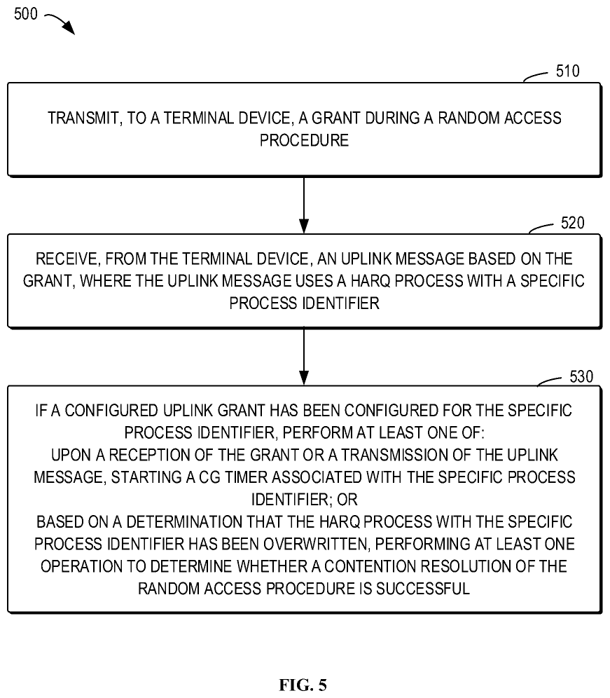

FIG. 6 illustrates a simplified block diagram of a device 600 that is suitable for implementing some example embodiments of the present disclosure. The device 600 may be provided to implement the communication device, for example the terminal device 210 or the network device 220 as shown in FIG. 2. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 3-5. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like.

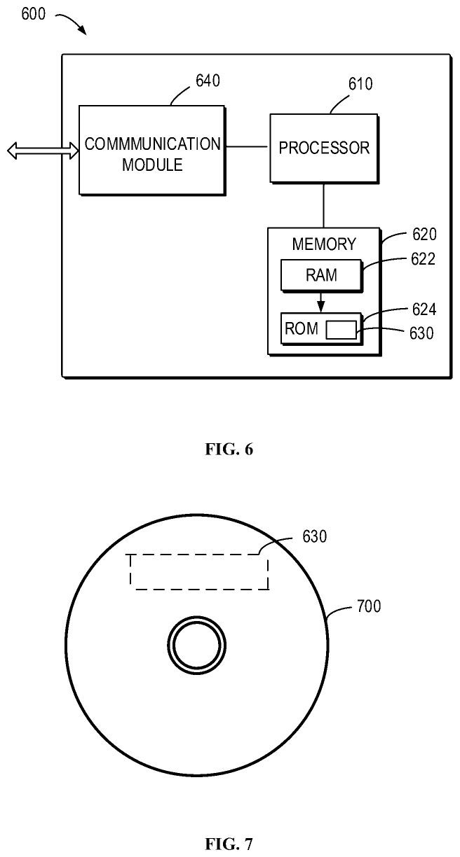

FIG. 7 illustrates a block diagram of an example of a computer readable medium 700 in accordance with some example embodiments of the present disclosure. The computer readable medium 700 has the program 630 stored thereon. It is noted that although the computer readable medium 700 is depicted in form of CD or DVD in FIG. 7, the computer readable medium 700 may be in any other form suitable for carry or hold the program 630.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 4-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device, a grant during a random access procedure;
transmit, to the network device, an uplink message based on the grant, the uplink message using a hybrid automatic repeat request (HARQ) process with a specific process identifier; and
based on a determination that a configured uplink grant has been configured for the specific process identifier, perform at least one of:
upon a reception of the grant or a transmission of the uplink message, starting a configured grant (CG) timer associated with the specific process identifier; or
based on a determination that the HARQ process with the specific process identifier has been overwritten, performing at least one operation to determine whether a contention resolution of the random access procedure is successful.

2. The terminal device of claim 1, wherein the terminal device is further caused to:
based on a determination that the CG timer associated with the specific process identifier expires and a contention resolution timer is running, restart the CG timer associated with the specific process identifier.

3. The terminal device of claim 2, wherein the terminal device is further caused to:
based on a determination that the contention resolution of the random access procedure is successful, stop the CG timer.

4. (canceled)

5. The terminal device of claim 1, wherein the terminal device is caused to:
based on a determination that a contention resolution timer is running and the HARQ process with the specific process identifier has been overwritten by a CG transmission, perform the at least one operation to determine whether the contention resolution of the random access procedure is successful.

6. The terminal device of claim 5, wherein the at least one operation comprises:
discarding a temporary cell-radio network temporary identifier (TC-RNTI) associated with the uplink message;
stopping the contention resolution timer; and
determining that the contention resolution is unsuccessful.

7. The terminal device of claim 5, wherein the at least one operation comprises:
based on a determination that a retransmission grant addressed to a TC-RNTI is received, determining that the contention resolution is unsuccessful; or
based on a determination that a physical downlink control channel (PDCCH) for the contention resolution is received, determining that the contention resolution is successful.

8. The terminal device of claim 7, wherein the at least one operation further comprises:
based on a determination that a retransmission grant addressed to a TC-RNTI is received, stopping the contention resolution timer.

9. The terminal device of claim 5, wherein the at least one operation comprises:
discarding a TC-RNTI associated with the uplink message; and
based on a determination that a PDCCH for the contention resolution is received, determining that the contention resolution is successful.

10. The terminal device of claim 9, wherein the at least one operation further comprises:
based on a determination that no PDCCH for the contention resolution is received before an expiry of the contention resolution timer, determining that the contention resolution is unsuccessful.

11. The terminal device of claim 5, wherein the terminal device is further caused to:
based on a determination that a contention resolution timer is running and a CG confirmation is triggered, overwrite the HARQ process with the specific process identifier by the CG transmission in a CG transmission occasion associated with the specific process identifier.

12. (canceled)

13. (canceled)

14. A network device comprising:
at least one processor; and
at least one memory storing instructions that, when executed by the at least one processor, cause the network device at least to:
transmit, to a terminal device, a grant during a random access procedure;
receive, from the terminal device, an uplink message based on the grant, the uplink message using a hybrid automatic repeat request (HARQ) process with a specific process identifier; and
based on a determination that a configured uplink grant has been configured for the specific process identifier, perform at least one of:
upon a reception of the grant or a transmission of the uplink message, starting a configured grant (CG) timer associated with the specific process identifier; or
based on a determination that the HARQ process with the specific process identifier has been overwritten, performing at least one operation to determine whether a contention resolution of the random access procedure is successful.

15. The network device of claim 14, wherein the network device is further caused to:
based on a determination that the CG timer associated with the specific process identifier expires and a contention resolution timer is running, restart the CG timer associated with the specific process identifier.

16. The network device of claim 15, wherein the network device is further caused to:
based on a determination that the contention resolution of the random access procedure is successful, stop the CG timer.

17. (canceled)

18. The network device of claim 14, wherein the network device is caused to:
based on a determination that a contention resolution timer is running and the HARQ process with the specific process identifier has been overwritten by a CG transmission, perform the at least one operation to determine whether the contention resolution of the random access procedure is successful.

19. The network device of claim 18, wherein the at least one operation comprises:
discarding a temporary cell-radio network temporary identifier (TC-RNTI) associated with the uplink message;
stopping the contention resolution timer; and
determining that the contention resolution is unsuccessful.

20. The network device of claim 18, wherein the at least one operation comprises:
based on a determination that the uplink message is unsuccessfully decoded, transmitting, to the terminal device, a retransmission grant addressed to a TC-RNTI; and
determining that the contention resolution is unsuccessful.

21. The network device of claim 20, wherein the at least one operation further comprises:
upon a transmission of the retransmission grant addressed to the TC-RNTI, stopping the contention resolution timer.

22. The network device of claim 18, wherein the at least one operation comprises:
based on a determination that the uplink message is successfully decoded, transmitting, to the terminal device, a physical downlink control channel (PDCCH) for the contention resolution; and
determining that the contention resolution is successful.

23. The network device of claim 18, wherein the at least one operation comprises:
discarding a TC-RNTI associated with the uplink message;
based on a determination that the uplink message is successfully decoded, transmitting, to the terminal device, a PDCCH for the contention resolution; and
determining that the contention resolution is successful.

24. The network device of claim 18, wherein the at least one operation comprises:
discarding a TC-RNTI associated with the uplink message; and
based on a determination that the uplink message is unsuccessfully decoded, determining that the contention resolution is unsuccessful.

25. The network device of claim 18, wherein the network device is further caused to:
based on a determination that a contention resolution timer is running and a CG confirmation is triggered, overwrite the HARQ process with the specific process identifier by the CG transmission in a CG transmission occasion associated with the specific process identifier.

26. (canceled)

27. (canceled)

28. A method comprising:
receiving, at a terminal device from a network device, a grant during a random access procedure;
transmitting, to the network device, an uplink message based on the grant, the uplink message using a hybrid automatic repeat request (HARQ) process with a specific process identifier; and
based on a determination that a configured uplink grant has been configured for the specific process identifier, performing at least one of:
upon a reception of the grant or a transmission of the uplink message, starting a configured grant (CG) timer associated with the specific process identifier; or
based on a determination that the HARQ process with the specific process identifier has been overwritten, performing at least one operation to determine whether a contention resolution of the random access procedure is successful.

29. A method comprising:
transmitting, at a network device to a terminal device, a grant during a random access procedure;
receiving, from the terminal device, an uplink message based on the grant, the uplink message using a hybrid automatic repeat request (HARQ) process with a specific process identifier; and
based on a determination that a configured uplink grant has been configured for the specific process identifier, performing at least one of:
upon a reception of the grant or a transmission of the uplink message, starting a configured grant (CG) timer associated with the specific process identifier; or
based on a determination that the HARQ process with the specific process identifier has been overwritten, performing at least one operation to determine whether a contention resolution of the random access procedure is successful.

30. (canceled)

31. (canceled)

32. A computer readable medium comprising program instructions for causing an apparatus to perform at least the method of claim 28.
